(19) United States
(12) Patent Application Publication
(10) Pub. No.: US 2005/0283361 A1
(43) Pub. Date: Dec. 22, 2005

(54) Audio signal processing method, audio signal processing apparatus, audio signal processing system and computer program product

(75) Inventors: Kazuyoshi Yoshii, Kyoto-shi (JP); Hiroshi Okuno, Kyoto-shi (JP); Masataka Goto, Tsukuba-shi (JP)

Correspondence Address: DARBY & DARBY P.C., P. O. BOX 5257, NEW YORK, NY, 10150-5257, US

(73) Assignees: Kyoto University, Kyoto (JP); National Institute of Advanced Industrial Science and Technology, Tokyo (JP)

(21) Appl. No.: 11/020,030

(22) Filed: Dec. 21, 2004

(30) Foreign Application Priority Data
Jun. 18, 2004 (JP) 2004-181881

(51) Int. Cl. G10L 19/04

(52) U.S. Cl. 704/219

(57) ABSTRACT

An apparatus and method for extracting a predetermined non-harmonic structured spectral component contained in an audio signal. Then, the extracted predetermined spectral component is increased or decreased. In this process, the spectrum of the audio signal is calculated by frequency analysis, so that a spectrum component corresponding to the predetermined non-harmonic structured spectral component is extracted and then increased or decreased. The extraction of the predetermined non-harmonic structured spectral component is performed with reference to a spectral component of a template stored in advance. In this process, the spectral component of the template is adapted in such a manner that the difference between the extracted spectral component and the spectral component of the template goes below or at a predetermined value. This allows the audio-signal contained predetermined non-harmonic structured spectral component to be independently increased or decreased without an influence on other spectral components.

### CROSS-REFERENCE TO RELATED APPLICATIONS

This Nonprovisional application claims priority under 35 U.S.C. §119(a) on patent Application No. 2004-181881 filed in Japan on Jun. 18, 2004, the entire contents of which are hereby incorporated by reference.

### BACKGROUND OF THE INVENTION

1. Field of the Invention

The present invention relates to an audio signal processing method, an audio signal processing apparatus, and an audio signal processing system for increasing or decreasing a predetermined non-harmonic structured spectral component contained in an audio signal, as well as to a computer program product for causing a computer to increase or decrease a predetermined non-harmonic structured spectral component contained in an audio signal.

2. Description of Related Art

Graphic equalizers are widely used as means for adjusting an audio signal such as music outputted from a speaker. (e.g., Japanese Patent Application Laid-Open No. 5-175773 (1993)). When a graphic equalizer is used, an audio signal reproduced from a CD (compact disk) or the like can be frequency-analyzed, and then the spectra of specific frequency ranges can be increased and decreased. Thus, when a bass drum sound contained in an audio signal outputted from a speaker is to be emphasized, the spectrum of a low frequency range may be increased.

Nevertheless, in many cases, a plurality of musical instruments are used in a musical performance, and hence a plurality of instrumental sounds are contained in the audio signal. Thus, when the spectrum of a specific frequency range of the audio signal is increased or decreased, a plurality of instrumental sounds having a spectrum in the specific frequency range should be increased or decreased similarly. For example, when the spectrum of a low frequency range is increased for the purpose of emphasizing a bass drum, the bass drum sound is increased, and so are other instrumental sounds such as a bass guitar sound that have a spectrum in the low frequency range of the target of increase.

As such, a graphic equalizer increases and decreases the spectra of specific frequency ranges of an audio signal, and hence all the instrumental sounds are similarly increased and decreased that have a spectrum in a specific frequency range of the target of increase or decrease. This has caused a problem that a specific instrumental sound cannot be solely increased or decreased without an influence on the other instrumental sounds, such as that a bass drum sound cannot be solely increased or decreased without an influence on a bass guitar sound.

### BRIEF SUMMARY OF THE INVENTION

The present invention has been devised with considering such a situation. An object of the invention is to provide an audio signal processing method, an audio signal processing apparatus, and a computer program product for extracting a predetermined non-harmonic structured spectral component contained in an audio signal and then increasing or decreasing the spectral component so as to allow the audio-signal contained predetermined spectral component to be independently increased or decreased without an influence on the other spectral components.

Another object of the invention is to provide an audio signal processing method, an audio signal processing apparatus, and a computer program product for calculating the spectrum of an audio signal by frequency analysis so as to allow a non-harmonic structured sound such as a drum sound to be extracted from the audio signal on the basis of the spectrum distribution.

Another object of the invention is to provide an audio signal processing method, an audio signal processing apparatus, and a computer program product for adapting a spectral component of a template in such a manner that the difference between an extracted spectral component and the spectral component of the template goes below or at a predetermined value, so as to improve the accuracy in the extraction of a non-harmonic structured sound such as a drum sound.

Another object of the invention is to provide an audio signal processing method, an audio signal processing apparatus, and a computer program product for selecting a predetermined number of extracted spectral components in ascending order of difference between the spectral component and a spectral component of a template and then updating the spectral component of the template into the median of the predetermined number of selected spectral components so as to permit the acquisition of a template in which the spectra of spectral components not having a non-harmonic structure are suppressed.

Another object of the invention is to provide an audio signal processing method, an audio signal processing apparatus, and a computer program product for quantizing an extracted spectral component and a spectral component of a template in the initial adaptation for the spectral component of the template so as to permit the suppression of an erroneous calculation that a large difference value is obtained despite that the two components are alike.

Another object of the invention is to provide an audio signal processing method, an audio signal processing apparatus, and a computer program product for increasing or decreasing an extracted predetermined spectral component in response to a received amount of increase or decrease so as to allow the power of the extracted predetermined spectral component to be adjusted independently of the power of the audio signal.

Another object of the invention is to provide an audio signal processing method, an audio signal processing apparatus, and a computer program product for causing the process of extracting a predetermined non-harmonic structured spectral component and the process of increasing or decreasing the spectral component to be performed in different apparatuses from each other, so as to allow the load to be distributed efficiently.

An audio signal processing method according to the first invention is characterized by comprising steps of extracting a predetermined non-harmonic structured spectral component contained in an audio signal; and increasing or decreasing the extracted predetermined spectral component.

An audio signal processing method according to the second invention is based on the first invention, and characterized by further comprising a step of calculating a spectrum of the audio signal by frequency analysis, wherein, in the step of extracting the predetermined non-harmonic structured spectral component, a spectrum is extracted that corresponds to the predetermined non-harmonic structured spectral component.

An audio signal processing method according to the third invention is based on the first invention, and characterized in that the step of extracting the predetermined non-harmonic structured spectral component is performed with reference to a spectral component of a template stored in advance, and the method further comprises a step of adapting the spectral component of the template in such a manner that a difference between the extracted spectral component and the spectral component of the template goes below or at a predetermined value.

An audio signal processing method according to the fourth invention is an audio signal processing method for extracting, with reference to a spectral component of a template stored in advance, a predetermined non-harmonic structured spectral component contained in an audio signal, and is characterized by comprising a step of adapting the spectral component of the template in such a manner that a difference between the extracted spectral component and the spectral component of the template goes below or at a predetermined value.

An audio signal processing method according to the fifth invention is based on the third or fourth invention, and is characterized in that the adapting step further comprises steps of calculating a difference between each extracted spectral component and the spectral component of the template in case that a plurality of spectral components have been extracted; selecting a predetermined number of spectral components in ascending order of the calculated difference; and updating the spectral component of the template into a median of the predetermined number of selected spectral components.

An audio signal processing method according to the sixth invention is based on the fifth invention, and characterized by further comprising a step of quantizing the extracted spectral components and the spectral component of the template in an initial adaptation for the spectral component of the template, wherein, in the step of calculating a difference, a difference is calculated between each extracted spectral component and the spectral component of the template which have been quantized.

An audio signal processing method according to the seventh invention is based on the first or fourth invention, and characterized by further comprising a step of receiving an amount of increase or decrease for the predetermined spectral component, wherein, in the increasing or decreasing step, the extracted predetermined spectral component is increased or decreased in response to the received amount of increase or decrease.

An audio signal processing method according to the eighth invention is characterized by comprising steps of extracting a predetermined non-harmonic structured spectral component contained in an audio signal; outputting onset time information of the extraction of the predetermined on-harmonic structured spectral component from the audio signal, the predetermined spectral component, and the audio signal; receiving the outputted onset time information, the predetermined spectral component, and the audio signal; and increasing or decreasing the received spectral component contained in the received audio signal, on the basis of the received onset time information.

An audio signal processing apparatus according to the ninth invention is characterized by comprising: extracting means for extracting a predetermined non-harmonic structured spectral component contained in an audio signal; and increasing and decreasing means for increasing or decreasing the predetermined spectral component extracted by the extracting means.

An audio signal processing apparatus according to the tenth invention is based on the ninth invention, and characterized by further comprising calculating means for calculating a spectrum of the audio signal by frequency analysis, wherein the extracting means extracts a spectrum corresponding to the predetermined non-harmonic structured spectral component.

An audio signal processing apparatus according to the eleventh invention is based on the tenth invention, and characterized in that the extraction of a predetermined non-harmonic structured spectral component is performed with reference to a spectral component of a template stored in a storage unit in advance, and the apparatus further comprises adapting means for adapting the spectral component of the template in such a manner that a difference between the extracted spectral component and the spectral component of the template goes below or at a predetermined value.

An audio signal processing apparatus according to the twelfth invention is an audio signal processing apparatus for extracting, with reference to a spectral component of a template stored in a storage unit in advance, a predetermined non-harmonic structured spectral component contained in an audio signal, and characterized by comprising adapting means for adapting the spectral component of the template in such a manner that a difference between the extracted spectral component and the spectral component of the template goes below or at a predetermined value.

An audio signal processing apparatus according to the thirteenth invention is based on the eleventh or twelfth invention, and characterized in that the adapting means further comprises: subtracting means for calculating a difference between each extracted spectral component and the spectral component of the template in case that a plurality of spectral components have been extracted; selecting means for selecting a predetermined number of spectral components in ascending order of the difference calculated by the subtracting means; and updating means for updating the spectral component of the template into a median of the predetermined number of spectral components selected by the selecting means.

An audio signal processing apparatus according to the fourteenth invention is based on the thirteenth invention, and characterized by further comprising quantizing means for quantizing the extracted spectral components and the spectral component of the template in an initial adaptation for the spectral component of the template, wherein the subtracting means calculates a difference between each extracted spectral component and the spectral component of the template which have been quantized by the quantizing means.

An audio signal processing apparatus according to the fifteenth invention is based on the ninth or twelfth invention, and characterized by further comprising receiving means for receiving an amount of increase or decrease for the predetermined spectral component, wherein the increasing and decreasing means increases or decreases the extracted predetermined spectral component in response to the amount of increase or decrease received by the receiving means.

An audio signal processing system according to the sixteenth invention is characterized by including: a first audio signal processing apparatus comprising: extracting means for extracting a predetermined non-harmonic structured spectral component contained in an audio signal; and outputting means for outputting onset time information of the extraction of the predetermined non-harmonic structured spectral component from the audio signal by the extracting means, the predetermined spectral component, and the audio signal; and a second audio signal processing apparatus comprising: receiving means for receiving the onset time information, the predetermined spectral component, and the audio signal outputted from the first audio signal processing apparatus; and increasing and decreasing means for increasing or decreasing the received spectral component contained in the received audio signal, on the basis of the onset time information received by the receiving means.

An audio signal processing apparatus according to the seventeenth invention is characterized by comprising: extracting means for extracting a predetermined non-harmonic structured spectral component contained in an audio signal; and outputting means for outputting onset time information of the extraction of the predetermined non-harmonic structured spectral component from the audio signal by the extracting means, the predetermined spectral component, and the audio signal.

An audio signal processing apparatus according to the eighteenth invention is characterized by comprising: receiving means for receiving onset time information of the extraction of a predetermined non-harmonic structured spectral component from an audio signal, the predetermined spectral component, and the audio signal; and increasing and decreasing means for increasing or decreasing the received spectral component contained in the received audio signal, on the basis of the onset time information received by the receiving means.

A computer program product according to the nineteenth invention is a computer program product for causing a computer to process an audio signal, wherein the computer program product comprises a computer readable storage medium having computer readable program code means embodied in the medium, and characterized in that the computer readable program code means comprises instructions for: extracting a predetermined non-harmonic structured spectral component contained in an audio signal; and increasing or decreasing the extracted predetermined spectral component.

A computer program product according to the twentieth invention is based on the nineteenth invention, and characterized in that the computer readable program code means further comprises an instruction for calculating a spectrum of the audio signal by frequency analysis, and the extracting instruction causes the computer to extract a spectrum corresponding to the predetermined non-harmonic structured spectral component.

A computer program product according to the twenty-first invention is based on the twentieth invention, and characterized in that the instruction for extracting a predetermined non-harmonic structured spectral component is executed with reference to a spectral component of a template stored in advance, and the computer readable program code means further comprises an instruction for adapting the spectral component of the template in such a manner that a difference between the extracted spectral component and the spectral component of the template goes below or at a predetermined value.

A computer program product according to the twenty-second invention is a computer program product for causing a computer to extract, with reference to a spectral component of a template stored in a memory in advance, a predetermined non-harmonic structured spectral component contained in an audio signal, and characterized in that the computer program product comprises a computer readable storage medium having computer readable program code means embodied in the medium, and characterized in that the computer readable program code means comprises an instruction for adapting the spectral component of the template in such a manner that a difference between the extracted spectral component and the spectral component of the template goes below or at a predetermined value.

A computer program product according to the twenty-third invention is based on the twenty-first or twenty-second invention, and characterized in that, in the adapting instruction, the computer readable program code means further comprises instructions for: calculating a difference between each extracted spectral component and the spectral component of the template in case that a plurality of spectral components have been extracted; selecting a predetermined number of spectral components in ascending order of the calculated difference; and updating the spectral component of the template into a median of the predetermined number of selected spectral components.

A computer program product according to the twenty-fourth invention is based on the twenty-third invention, and characterized in that the computer readable program code means further comprises an instruction for quantizing the extracted spectral components and the spectral component of the template in an initial adaptation for the spectral component of the template; and the instruction for calculating a difference causes the computer to calculate a difference between each extracted spectral component and the spectral component of the template which have been quantized.

A computer program product according to the twenty-fifth invention is based on the nineteenth or twenty-second invention, and characterized in that the computer readable program code means further comprises an instruction for receiving an amount of increase or decrease for the predetermined spectral component; and the increasing or decreasing instruction causes the computer to increase or decrease the extracted predetermined spectral component in response to the received amount of increase or decrease.

A computer program product according to the twenty-sixth invention is a computer program product for causing a computer to process an audio signal, wherein the computer program product comprises a computer readable storage medium having computer readable program code means embodied in the medium, and characterized in that the computer readable program code means comprises instructions for: extracting a predetermined non-harmonic structured spectral component contained in an audio signal; and outputting onset time information of the extraction of the predetermined non-harmonic structured spectral component from the audio signal, the predetermined spectral component, and the audio signal.

A computer program product according to the twenty-seventh invention is a computer program product for causing a computer to process an audio signal, wherein the computer program product comprises a computer readable storage medium having computer readable program code means embodied in the medium, and the computer readable program code means comprises instructions for: receiving onset time information of the extraction of a predetermined non-harmonic structured spectral component from an audio signal, the predetermined spectral component, and the audio signal; and increasing or decreasing the received spectral component contained in the received audio signal, on the basis of the received onset time information.

In the first, ninth and nineteenth-inventions, a predetermined non-harmonic structured spectral component contained in an audio signal is extracted. An example of the non-harmonic structured tone is a sound of a percussion instrument such as a drum. Then, in the audio signal, the extracted predetermined spectral component is increased or decreased. For example, when the extracted spectral component of a drum is increased, the drum sound is emphasized. On the contrary, when the extracted spectral component of a drum is decreased, the drum sound is cancelled. As such, a predetermined spectral component contained in an audio signal is solely extracted and can be independently increased or decreased without an influence on the other spectral components.

In the second, tenth and twentieth inventions, the spectrum of an audio signal is calculated by frequency analysis. The sound of a percussion instrument such as a drum is of non-harmonic structure, and have slight or no harmonic structure. The sounds of other types of musical instruments have a harmonic structure. Thus, on the basis of the spectrum distribution, the non-harmonic structured sound of a percussion instrument such as a drum can be discriminated from the harmonic structured sounds of other types of musical instruments. That is, the non-harmonic structured sound of a percussion instrument such as a drum can be extracted from the audio signal on the basis of the spectrum distribution.

In the third, fourth, eleventh, twelfth, twenty-first and twenty-second inventions, the extraction of a predetermined non-harmonic structured spectral component is performed on the basis of a spectral component of a template stored in advance. For example, when a drum sound is to be extracted, a template of a drum sound is stored in a storage unit in advance. Nevertheless, it is extremely rare that the drum sound contained in an audio signal agrees completely with the drum sound of the template stored in advance. These sounds usually differ from each other more or less. Thus, the spectral component of the template is adapted in such a manner that the difference between the extracted spectral component and the spectral component of the template goes below or at a predetermined value. This ensures that the drum sound contained in the audio signal agrees approximately with the drum sound of the template stored in advance. This improves the accuracy in the extraction of the drum sound, and hence permits accurate increase or decrease of the extracted drum sound. Further, this approach allows various drum sounds to be extracted on the basis of a single template.

In the fifth, thirteenth and twenty-third inventions, in case that a plurality of spectral components have been extracted, the difference between each extracted spectral component and a spectral component of a template is calculated. Then, a predetermined number of spectral components are selected in ascending order of the calculated difference. The spectral component of the template is then updated into the median of the predetermined number of selected spectral components, so that the template is adapted. The spectral structure of a non-harmonic structured spectral component usually appears in the same position of the selected spectral components. In contrast, the spectral structure of a harmonic structured spectral component seldom appears in the same position of the selected spectral components. Thus, when the median is used, the spectral structure of the non-harmonic structured spectral component is expected to be retained, whereas harmonic structured musical instrumental sounds other than the sound of a percussion instrument such as a drum are seldom retained. As a result, the spectra of spectral components not having a non-harmonic structure are suppressed.

In the sixth, fourteenth and twenty-fourth inventions, extracted spectral components and a spectral component of a template are quantized in the initial adaptation for the spectral component of the template, and then the difference is calculated between each extracted spectral component and the spectral component of the template which have been quantized. Without template adaptation, since it is extremely rare that a drum sound, for example, contained in an audio signal agrees completely with a template drum sound, a large difference could be erroneously calculated despite that the two sounds are alike. In contrast, when the extracted spectral components and the spectral component of the template are quantized, and when a representative value such as the median is used in the difference calculation, it is suppressed that a large difference is erroneously calculated despite that the two sounds are alike.

In the seventh, fifteenth and twenty-fifth inventions, an amount of increase or decrease for a predetermined spectral component is received, and then the extracted predetermined spectral component is increased or decreased in response to the received amount of increase or decrease. For example, an increase and decrease knob similar to a volume control knob for the power of the audio signal may be used for inputting the amount of increase or decrease. A user adjusts the increase and decrease knob so as to vary the power of the extracted predetermined spectral component independently of the power of the audio signal.

In the eighth, sixteenth, seventeenth, eighteenth, twenty-sixth and twenty-seventh inventions, in a first audio signal processing apparatus, a predetermined non-harmonic structured spectral component contained in an audio signal is extracted. Then, outputted are onset time information of the extraction of the predetermined non-harmonic structured spectral component from the audio signal, the predetermined spectral component, and the audio signal. These outputs may be recorded in a recording medium or transmitted through a communication network. In a second audio signal processing apparatus, the onset time information, the predetermined spectral component, and the audio signal which have been outputted are received. Then, the received spectral component contained in the received audio signal is increased or decreased on the basis of the received onset time information. Various types of information described here may be received in the form of a recording medium or through a communication network. The extraction of a predetermined non-harmonic structured spectral component is a task of heavy load, and hence is desired to be carried out by a high performance computer or the like. In contrast, the increasing or decreasing of a predetermined spectral component is a task of light load, and hence may be carried out by a general audio device or the like. As such, according to the invention, the load is efficiently distributed so that even an audio device of low performance can increase or decrease the predetermined non-harmonic structured spectral component.

According to the first, ninth and nineteenth inventions, a predetermined spectral component contained in an audio signal can be independently increased or decreased without an influence on the other spectral components.

According to the second, tenth and twentieth inventions, a non-harmonic structured sound such as a drum sound can be extracted from an audio signal on the basis of the spectrum distribution.

According to the third, fourth, eleventh, twelfth, twenty-first and twenty-second inventions, the accuracy is improved in the extraction of a non-harmonic structured sound such as a drum sound. This permits accurate increase or decrease of the extracted drum sound. Further, the invention allows various non-harmonic structured sounds such as various drum sounds to be extracted on the basis of a single template.

According to the fifth, thirteenth and twenty-third inventions, a template is obtained in which the spectra of spectral components not having a non-harmonic structure are suppressed.

According to the sixth, fourteenth and twenty-fourth inventions, it is suppressed that a large difference is erroneously calculated despite that an extracted spectral component and a spectral component of a template are alike.

According to the seventh, fifteenth and twenty-fifth inventions, the power of an extracted predetermined spectral component can be adjusted independently of the power of the audio signal.

According to the eighth, sixteenth, seventeenth, eighteenth, twenty-sixth and twenty-seventh inventions, the process of extracting a predetermined non-harmonic structured spectral component and the process of increasing or decreasing the spectral component are carried out by different apparatuses from each other. Thus, the load is efficiently distributed so that even a general audio device or the like can increase or decrease a predetermined non-harmonic structured spectral component.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing an exemplary configuration of a computer (audio signal processing apparatus) according to the invention;

FIG. 2 is a graph showing an example of a low pass filter function F(f);

FIG. 3A, FIG. 3B and FIG. 3C are graphs each showing an example of the distance between a template T_{g} and a spectrum segment Pᵢ;

FIG. 4A and FIG. 4B are diagrams each showing an example of determination whether a spectrum is contained or not;

FIG. 5A, FIG. 5B and FIG. 5C are schematic diagrams each illustrating a time series (frame series) of graphs showing an example of increasing or decreasing a drum sound at onset time;

FIG. 6 is a flow chart showing an exemplary procedure of increasing or decreasing a drum sound by means of template adaptation;

FIG. 7 is a flow chart showing, in the form of a subroutine, an exemplary detail of the procedure of template adaptation shown in FIG. 6;

FIG. 8 is a flow chart showing, in the form of a subroutine, an exemplary detail of the procedure of template matching shown in FIG. 6;

FIG. 9 is a flow chart showing, in the form of a subroutine, an exemplary detail of the procedure of spectrum segment adjustment shown in FIG. 8; and

FIG. 10 is a block diagram showing an exemplary configuration of an audio signal processing apparatus according to the invention embodied as an audio device.

### DETAILED DESCRIPTION OF THE PREFERRED EMBODIMENTS

The invention is described below in detail with reference to drawings showing its embodiments.

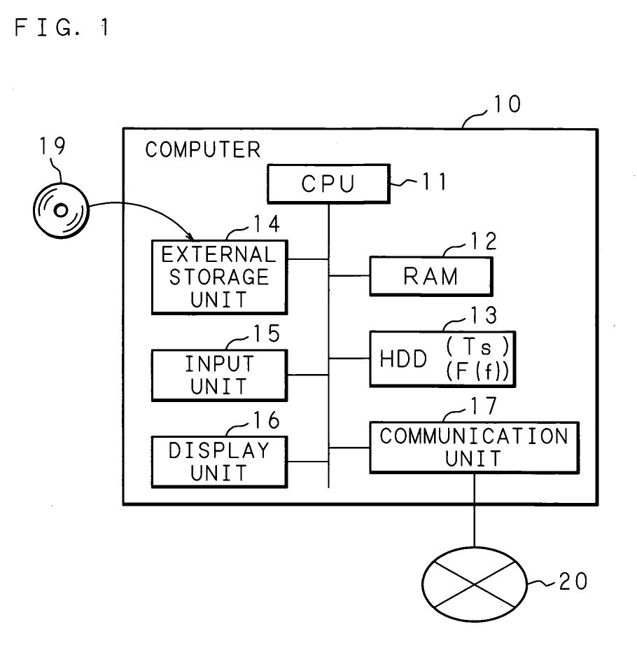

FIG. 1 is a block diagram showing an exemplary configuration of a computer (audio signal processing apparatus) according to the invention. The computer 10 comprises: a CPU (central processing unit) 11; a RAM (random access memory) 12 such as a DRAM; an HDD (hard disk drive) 13; an external storage unit 14 such as a flexible disk drive or a CD-ROM drive; and a communication unit 17 for performing communications with a communication network 20 such as a LAN (local area network) or the Internet. The computer 10 further comprises: an input unit 15 provided with a keyboard and a mouse; and a display unit 16 provided with a CRT display, a liquid crystal display, or the like.

The CPU 11 controls the system components 12 through 17 described above. The CPU 11 causes the RAM 12 to store programs and data received through the input unit 15 or the communication unit 17, programs and data read out from a recording medium by the HDD 13 or the external storage unit 14 and the like. Further, the CPU 11 performs various processing such as the execution of the programs stored in the RAM 12 and arithmetic operations on the stored data, and causes the RAM 12 to store the results of the various processing as well as temporary data used in the various processing. The data such as operation results temporarily stored in the RAM 12 is transferred to the HDD 13 and outputted through the display unit 16 or the communication unit 17 under the control of the CPU 11.

The HDD 13 stores an audio signal (sound data) received from the outside by the computer 10. The computer 10 extracts a non-harmonic structured sound (spectral component) such as the sound of a percussion instrument such as a drum contained in the audio signal, and then increases or decreases the extracted sound. Amount of increase or decrease of the extracted sound is received through the input unit (receiving means) 15. The non-harmonic structured sound is a sound having almost no harmonic structure. However, the sound may contain a very weak harmonic structure negligible in comparison with general musical instrumental sounds having a harmonic structure.

The CPU 11 serves as means (calculating means) for calculating the power spectrum P(t, f) of an audio signal at a frame t and frequency f. In an example, the audio signal is sampled in 44.1 kHz. Then, an STFT (Short Time Fourier Transformation) is calculated using a Hanning window having a window width of 4096 points (a frequency resolution of 10.8 Hz) and a window shift length of 441 points (a time resolution of 10 ms), so that the power spectrum P(t, f) is obtained.

The CPU 11 serves also as means for detecting an onset time candidate oᵢ of a drum. The onset time candidate oᵢ of the drum is detected, for example, as a time (frame) where the power spectrum rises steeply. In three successive frames in the time direction (t=a+1, a, a+1), in case that the differential Q(t, f)={∂P(t, f)/∂t} of P(t, f) with respect to time (frame) satisfies Q(t, f)>0, the CPU 11 calculates the differential Q(a, f) at frame a. On the contrary, in case that Q(t, f)>0 is not satisfied in the three successive frames, the CPU 11 sets Q(a, f)=0. Then, at each frame t, the CPU 11 multiplies Q(t, f) by a low pass filter function F(f) based on the typical frequency characteristics of a drum, and calculates a sum S(t) in the frequency direction according to the following equation.

$$S ( t ) = {\sum }_{f = 1}^{2048} F ( f ) Q ( t , f )$$

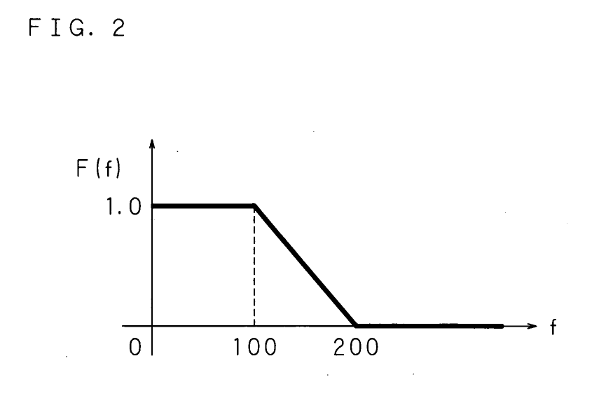

FIG. 2 is a graph showing an example of the low pass filter function F(f). The horizontal axis indicates frequency f, while the vertical axis indicates F(f). The low pass filter function F(f) is stored in the HDD 13 in advance. The CPU 11 calculates time where the sum S(t) in the frequency direction reaches a maximum, and then determines the time to be an onset time candidate oᵢ. Before the detection of the maximum, the CPU 11 preferably performs 11-frame smoothing on S(t) by a method according to Savitzky and Golay.

The HDD (storage unit) 13 stores a seed template Tₛ created on the basis of a single tone signal of a drum. The seed template Tₛ is a power spectrum having a predetermined time length and acquired by STFT starting at an onset time. The seed template Tₛ is in the form of a matrix the row of which corresponds to time and the column of which corresponds to frequency. Each component is specified as a seed template Tₛ(t, f) (where 1≦t≦15 and 1≦f≦2048).

The CPU 11 serves as means (adapting means) for adapting the seed template Tₛ to an audio signal of the target of analysis. The CPU 11 updates the seed template Tₛ as described later, and repeats the update of the template after that. The template having undergone the g-th update is expressed by T_{g}. Since the seed template Tₛ is the initially inputted (g=0) template, T₀=Tₛ. The CPU 11 serves as means (calculating means) for extracting a spectrum segment Pᵢ (i=1, . . . , N, where N is the total number of detected onset time candidates) which is a power spectrum having a predetermined time length and starting at an onset time candidate oᵢ (ms) detected from the audio signal of the target of analysis. The spectrum segment Pᵢ is a matrix having the same size as the template T_{g}.

The extraction of the spectrum segment is carried out as described above. Nevertheless, the time resolution of 10 ms is not sufficient for the template to be adapted accurately. Thus, a correction process is preferably performed on the onset time candidate oᵢ. In an example, the CPU 11 serves as means for correcting the onset time candidate oᵢ (ms) into oᵢ′ (ms), and then extracts a spectrum segment Pᵢ for the corrected onset time candidate oᵢ′ (ms). For example, in case that a spectrum segment selected from those of oᵢ′=oᵢ−5 ms or oᵢ+5 ms has better quality than that extracted from those of oi (ms), the CPU 11 adopts as the spectrum segment Pᵢ the power spectrum extracted from those starting at time oᵢ′ (ms).

In an example, the CPU 11 extracts a spectrum segment Pᵢ j starting at time oᵢ+j (ms) (where j=−5 ms, 0 ms and 5 ms). Then, the CPU 11 calculates the correlation value Corr(j) between the template T_{g}′ and the spectrum segment P_{i,j} according to the following equation.

$$Corr ( j ) = {\sum }_{t = 1}^{15} {\sum }_{f = 1}^{2048} F ( f ) {T}_{g} ( t , f ) \cdot F ( f ) {P}_{i , j} ( t , f )$$

The CPU 11 then acquires an offset value J maximizing the correlation value Corr(j), and determines the Pᵢ j with the obtained offset value J to be Pᵢ.

The CPU 11 further calculates a template T_{g}′ and a spectrum segment Pᵢ′ which are generated by multiplying the template T_{g} and the spectrum segment Pᵢ respectively by the low pass filter function F(f) according to the following equations.
T_{g}′(t,f)=F(f) T_{g}(t,f)
Pᵢ′(t,f)=F(f) Pᵢ(t,f)

The CPU 11 serves as means (selecting means) for selecting a predetermined number M of spectrum segments that are alike to the template T_{g} in the course of adaptation. The predetermined number M has a constant ratio (0.1 in the present embodiment) to the total number of spectrum segments (detected onset time candidates). The CPU 11 serves also as subtracting means. That is, the CPU 11 calculates the distance (difference) Dᵢ between the template T_{g} and the spectrum segment Pᵢ, and then selects a predetermined number M of spectrum segments in ascending order of the calculated distance. The distance Dᵢ may be calculated according to the following equation.

$${D}_{i} = \sqrt{\{ {\sum }_{t = 1}^{15} {\sum }_{f = 1}^{2048} {( {T}_{g}^{′} ( t , f ) - {P}_{i}^{′} ( t , f ) )}^{2} \}}$$

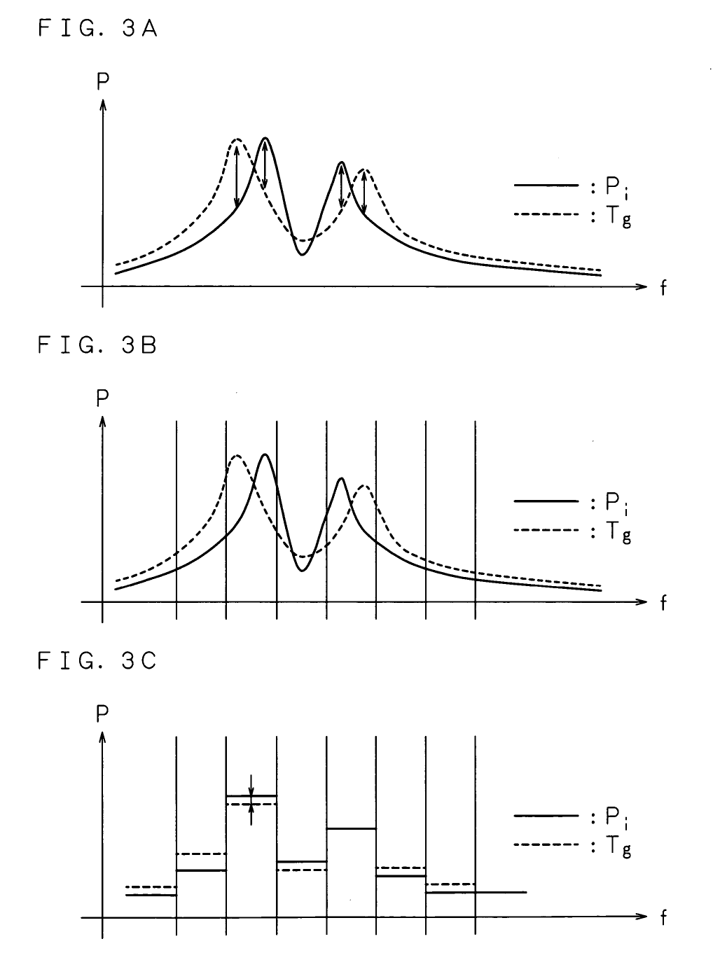

In case that the distance Dᵢ is calculated according to the above equation, a large distance is calculated despite that the power peak position in the template T_{g} differs merely slightly from that in the spectrum segment Pᵢ. This occurs a possibility that accurate calculation of the distance can not be executed. FIG. 3A, FIG. 3B and FIG. 3C are graphs each showing an example of the distance between a template T_{g} and a spectrum segment Pᵢ. The horizontal axis indicates frequency f, while the vertical axis indicates power P. A solid line indicates the spectrum segment Pᵢ, while a broken line indicates the template T_{g}. As shown in FIG. 3A, owing to merely a small difference in the power peak position, a notably large distance is erroneously calculated between the two spectra.

In order to avoid this situation, in the invention, the seed template T₀ (Tₛ) and the spectrum segment Pᵢ are quantized with lower time and frequency resolutions in the initial adaptation as shown in FIG. 3B and FIG. 3C. Then, the distance Dᵢ is calculated. In an example, the time resolution after quantization is made to be 2 frames (20 ms), and the frequency resolution is made to be 5 bins (54 Hz). The CPU 11 serves also as quantizing means. That is, the CPU 11 quantizes the seed template To and the spectrum segment Pᵢ, and then calculates quantized spectra T₀″(t″, f″) and Pᵢ″(t″, f″) according to the following equations, respectively.

$${T}_{0}^{″} ( {t}^{″} , {f}^{″} ) = {\sum }_{t = 2 {t}^{″} - 1}^{2 {t}^{″}} {\sum }_{f = 5 {f}^{″} - 4}^{5 {f}^{″}} {T}_{0}^{′} ( t , f )$$

$${P}_{0}^{″} ( {t}^{″} , {f}^{″} ) = {\sum }_{t = 2 {t}^{″} - 1}^{2 {t}^{″}} {\sum }_{f = 5 {f}^{″} - 4}^{5 {f}^{″}} {P}_{i}^{′} ( t , f )$$

The CPU 11 then calculates the distance Dᵢ between the seed template T₀ (Tₛ) and the spectrum segment Pᵢ according to the following equation.

$${D}_{i} = \sqrt{\{ {\sum }_{{t}^{″} = 1}^{15 / 2} {\sum }_{{f}^{″} = 1}^{2048 / 5} {( {T}_{0}^{″} ( {t}^{″} , {f}^{″} ) - {P}_{i}^{″} ( {t}^{″} , {f}^{″} ) )}^{2} \}}$$

The CPU 11 serves also as updating means for updating the template T_{g} into a new template T_{g+1} on the basis of the predetermined number M of selected spectrum segments Pₛ (s=1, . . . , M). It is probable that the spectral structure of a drum sound appears in the same position in each spectrum segment PS. In contrast, the sound spectral components of musical instruments other than the drum seldom appear in the same position in each spectrum segment Pₛ. Thus, the CPU 11 determines as a new template T_{g+1} the median of the selected spectrum segments Pₛ as follows.
T_{g+1}(t,f)=medianPₛ(t,f)

When the median is used as described here, the spectral structure of the drum sound is expected to be retained. In contrast, instrumental sounds other than the drum sound are seldom retained. Thus, the sound spectral components of musical instruments other than the drum are expected to be suppressed. As such, the seed template To can be adapted to a drum sound in an audio signal containing plural types of instrumental sounds.

When the determination of a new template T_{g+1} is repeated, the drum sound of the template approaches the drum sound contained in the audio signal so that the template adaptation is achieved. In the course of repetition of the determination, the amount of change in the template goes smaller so that the adaptation converges. The CPU 11 serves as means for comparing the present template T_{g} with a new template T_{g+1}, and thereby determining the convergence of adaptation in case that the difference between the two spectra goes below or at a predetermined value. At that time, the CPU 11 adopts the new template T_{g+1}, as an adapted template TA.

The CPU 11 serves also as means (extracting means) for performing template matching based on the adapted template TA and thereby determining whether the drum is generating a sound at an onset time candidate oᵢ or not. The CPU 11 multiplies the adapted template T_{A} by the low pass filter function F(f) described above, and thereby calculates according to the following equation a weight function ω that indicates the magnitude of characteristics on the spectrum at each frame t of the adapted template T_{A} and at each frequency f.
ω(t, f)=F(f)·T_{A}(t, f)

In case that the power of each spectrum segment differs from that of the template, it is not sure that the determination whether the template is contained in the spectrum segment or not is performed appropriately. Thus, for the purpose of ensuring appropriate template matching, the power of each spectrum segment is preferably adjusted such that the power matches with that of the template. The CPU 11 selects the frequency f_{t,k} (k=1, . . . , 15) of a characteristic point having the k-th largest value of ω(t, f_{t, k}) at frame t in the template T_{A}, and then calculates the power difference ηᵢ(t, f_{t,k}) according to the following equation.
ηᵢ(t, f_{t,k})=Pᵢ(t, f_{t,k})−T_{A}(t, f_{t,k})

Then, the CPU 11 selects the value of ηᵢ(t, f_{t,k}) at the first quartile point (the point at 25% of the sample set sorted in ascending order), and thereby adopts this value as the power difference δᵢ(t) at frame t. In case that the number of frames that do not satisfy δᵢ(t)≧Ψ (Ψ is a negative constant) exceeds a predetermined threshold value R, the CPU 11 determines that TA is not contained in the spectrum segment Pᵢ.

The CPU 11 calculates the final power difference Δᵢ (the adjustment value for the spectrum segment: −Δᵢ) according to the following equation.

$${Δ}_{i} = \frac{{{\sum }_{\{ t / {δ}_{i} ( t ) > Ψ \}}}^{{δ}_{i} ( t ) ω ( t , {f}_{t , {K}_{i} ( t )} )}}{{{\sum }_{\{ t / {δ}_{i} ( t ) > Ψ \}}}^{ω ( t , {f}_{t , {K}_{i} ( t )} )}}$$

In case that Δᵢ≦Θ (Θ is a constant) is satisfied, the CPU 11 determines that the adapted template T_{A} is not contained in the spectrum segment Pᵢ. In case that Δᵢ≦Θ is not satisfied, the CPU 11 determines that the adapted template T_{A} is contained in the spectrum segment Pᵢ, and then calculates an adjusted spectrum segment Pᵢ′ according to the following equation.
Pᵢ′(t, f)=Pᵢ(t, f)−Δᵢ

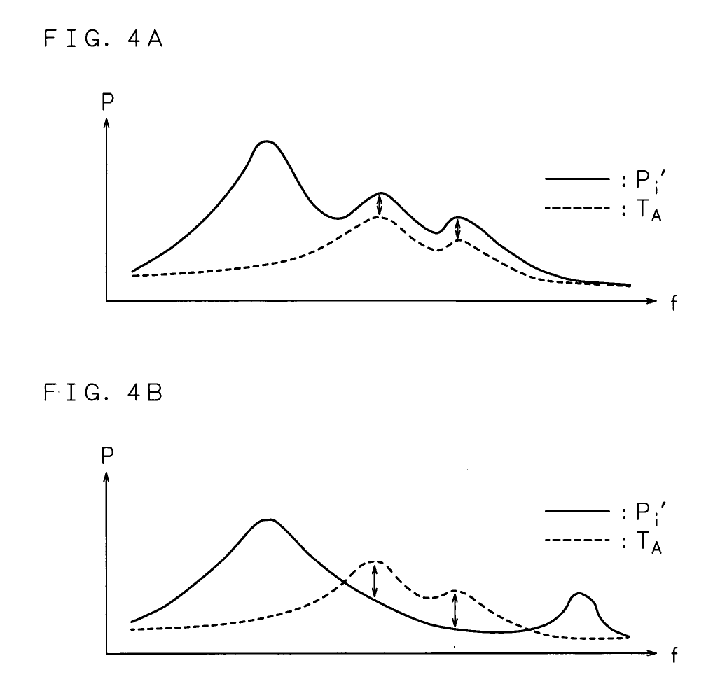

The CPU 11 serves also as means for calculating the distance between the adapted template TA and the adjusted spectrum segment Pᵢ′. At the calculation of the distance, the CPU 11 determines whether the spectrum of the adapted template T_{A} is contained in the spectrum of the spectrum segment Pᵢ′. FIG. 4A and FIG. 4B are graphs each showing an example of determination whether a spectrum is contained or not. The horizontal axis indicates frequency f, while the vertical axis indicates power P. A solid line indicates a spectrum segment Pᵢ′, while a broken line indicates an adapted template T_{A}. For example, in case that a spectrum segment Pᵢ′(t, f) is larger than the adapted template T_{A}(t, f) all over the frequency range as shown in FIG. 4A, it is determined that the spectrum segment Pᵢ′ (t, f) contains not only the spectral component of a drum sound but also the spectral components of other musical instruments, and that the adapted template T_{A}(t, f) is contained in the spectrum segment Pᵢ′ (t, f) In the other cases as shown in FIG. 4B, it is determined that the adapted template T_{A}(t, f) is not contained in the spectrum segment Pᵢ′(t, f). The CPU 11 calculates a local distance measure γᵢ(t, between the adapted template T_{A} and the spectrum segment Pᵢ′ at frame t and frequency f according to the following equation.

$${γ}_{i} ( t , f ) = \{ \begin{matrix}0 & ( if {P}_{i}^{′} ( t , f ) - {T}_{A} ( t , f ) \geq Ψ ) \\ 1 & ( otherwise )\end{matrix}$$

Here, Ψ is a negative constant. When a non-zero negative number is used as Ψ, a small variation in the spectral component can be absorbed. The CPU 11 integrates the distance measure γᵢ over the time-frequency domain, and thereby acquires the overall distance Γᵢ. At that time, the CPU 11 performs a weighting operation of multiplying the distance measure by the weight function co according to the following equation.

$${Γ}_{i} = {\sum }_{t = 1}^{15} {\sum }_{f = 1}^{2048} ω ( t , f ) {γ}_{i} ( t , f )$$

The CPU 11 serves also as means for determining whether the target drum has generated a sound in the spectrum segment Pᵢ′(t, f) portion or not. More specifically, in case that Γᵢ<θ is satisfied, the CPU 11 determines that the target drum has generated a sound, and then decides the onset time candidate oᵢ as the onset time.

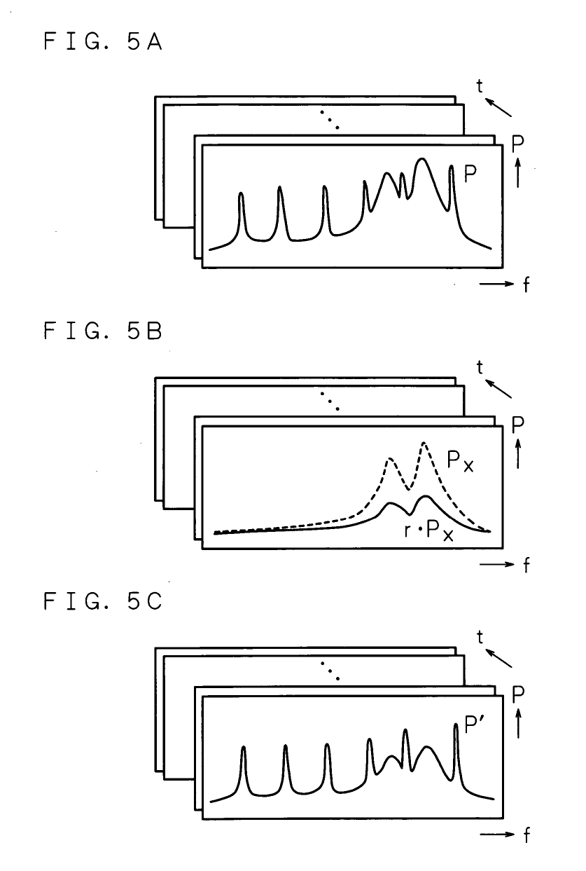

The CPU 11 serves also as increasing and decreasing means for increasing or decreasing a drum sound at onset time. FIG. 5A, FIG. 5B and FIG. 5C are schematic diagrams each illustrating a time series (frame series) of graphs showing an example of increasing or decreasing a drum sound at onset time. The horizontal axis indicates frequency f, while the vertical axis indicates power P. Symbol t indicates time (frame). As shown in FIG. 5B, the CPU 11 multiplies a spectrum Pₓ corresponding to the adapted template TA by r (0≦r≦1) (the broken line in FIG. 5B indicates Pₓ without the multiplication by r, while the solid line indicates Pₓ multiplied by r). The CPU 11 then subtracts r·Pₓ from the spectrum P of the audio signal shown in FIG. 5A, and thereby calculates an audio signal P′ shown in FIG. 5C where the drum sound is decreased. In case that the drum sound is to be increased, the CPU 11 adds r·Pₓ to the spectrum P of the audio signal.

As described above, the CPU 11 calculates various numerical data. The numerical data calculated by the CPU 11 is stored in the RAM 12 or the HDD 13. Further, when the CPU 11 is to calculate other numerical data on the basis of already calculated numerical data, the CPU 11 reads necessary numerical data from the RAM 12 before the new calculation.

A computer program stored in a recording medium 19 such as a CD-ROM is read by the external storage unit 14 and then temporarily stored in the HDD 13 or the RAM 12. After that, the computer program is executed by the CPU 11. This approach allows the CPU 11 to serve as various system components described above. Alternatively, a computer program may be received via the communication unit 17 from another apparatus connected to the communication network 20, and then temporarily stored in the HDD 13 or the RAM 12. After that, the computer program may be executed by the CPU 11.

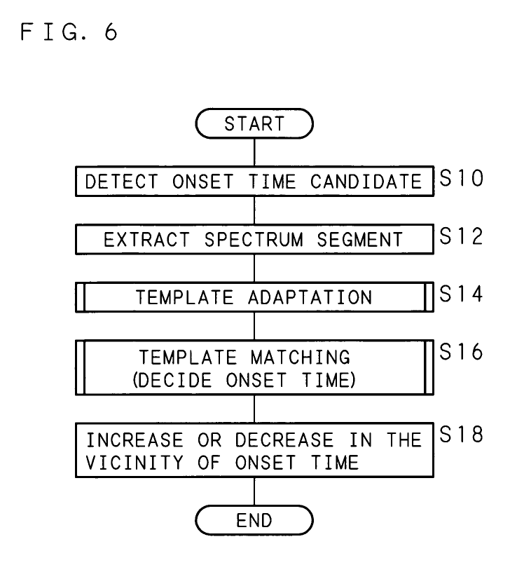

Described below is a practical procedure of increasing or decreasing a drum sound by using a computer (audio signal processing apparatus) according to the invention. FIG. 6 is a flow chart showing an exemplary procedure of increasing or decreasing a drum sound by means of template adaptation. The procedure shown in the flow chart of FIG. 6 is carried out when the CPU 11 executes a computer program stored in the HDD 13 or the RAM 12.

The computer 10 reads an audio signal (sound data), for example, from a recording medium 19 in the external storage unit 14, and then stores the data into the HDD 13. Alternatively, the computer 10 may store into the HDD 13 sound data (an audio signal, hereafter) that are inputted through a sound card (not shown) and then converted into an audio signal. The computer 10 further reads a drum sound template (seed template Tₛ), for example, from a recording medium 19 in the external storage unit 14, and then stores the data into the HDD 13.

The CPU 11 first performs frequency analysis on the audio signal so as to calculate the power spectrum P, and then stores into the HDD 13 the data of the calculated power spectrum P. The CPU 11 then detects an onset time candidate oᵢ (S10) on the basis of a power spectrum P extracted and stored in the HDD 13. The CPU 11 stores the detected onset time candidate oᵢ into the HDD 13. On the basis of the onset time candidate oᵢ, the CPU 11 extracts (calculates) a spectrum segment Pᵢ (S12), and then stores the data of the extracted spectrum segment Pᵢ into the HDD 13. After that, the CPU 11 performs template adaptation (template adaptation) (S14), and thereby updates the updated template T_{g} (seed template Tₛ in the beginning) stored in the HDD 13. As a result, the template converges into an adapted template T_{A}.

After that, the CPU 11 performs template matching by using the adapted template T_{A}, and then decides the onset time (extracts a drum sound) (S16). The CPU 11 stores the decided onset time into the HDD 13. Using the adapted template TA, the CPU 11 increases or decreases the power spectrum in the vicinity of the decided onset time (S18), and thereby creates an audio signal used as an output. The CPU 11 stores this audio signal into the HDD 13. The increase or decrease of the power spectrum is performed in response to the amount of increase or decrease received through the input unit 15. The audio signal (sound data) used as an output may be outputted and recorded into a recording medium 19 in the external storage unit 14. Alternatively, the audio signal used as an output may be outputted through a sound card not shown.

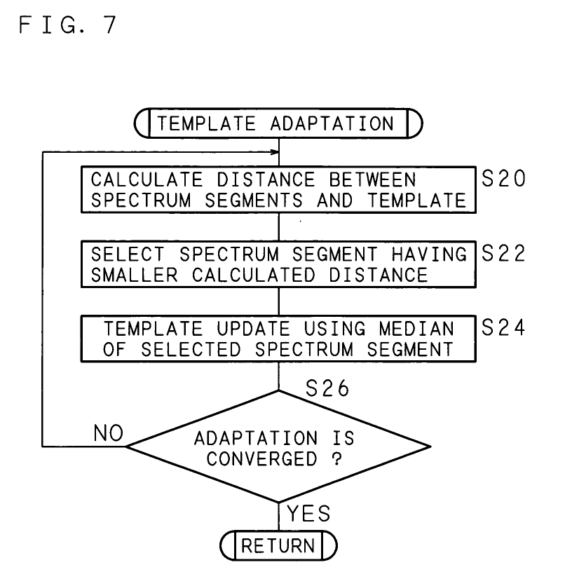

FIG. 7 is a flow chart showing, in the form of a subroutine, an exemplary detail of the procedure of template adaptation (S14) shown in FIG. 6. The CPU 11 first calculates the distance Dᵢ between the spectrum segment Pᵢ and the template T_{g} (S20), and then stores the calculated distance Dᵢ into the HDD 13. In the initial process, the distance Dᵢ is calculated after quantization. The CPU 11 then selects spectrum segments Pₛ having smaller calculated distances Dᵢ (S22), and then performs template update using the median of the selected spectrum segments (S24). Then, the CPU 11 compares the amount of change between the not-yet-updated template and the updated template (S26). In case that the amount of change between the templates before and after the update goes below or at a predetermined value, that is, in case that the adaptation has been converged (S26: YES), the CPU 11 terminates the template adaptation process. In contrast, in case that the amount of change between the templates before and after the update does not yet go below or at the predetermined value, that is, in case that the adaptation has not yet converged (S26: NO), the CPU 11 repeats the processes of S20, S22 and S24 described above until the amount of change between the templates before and after the update goes below or at the predetermined value.

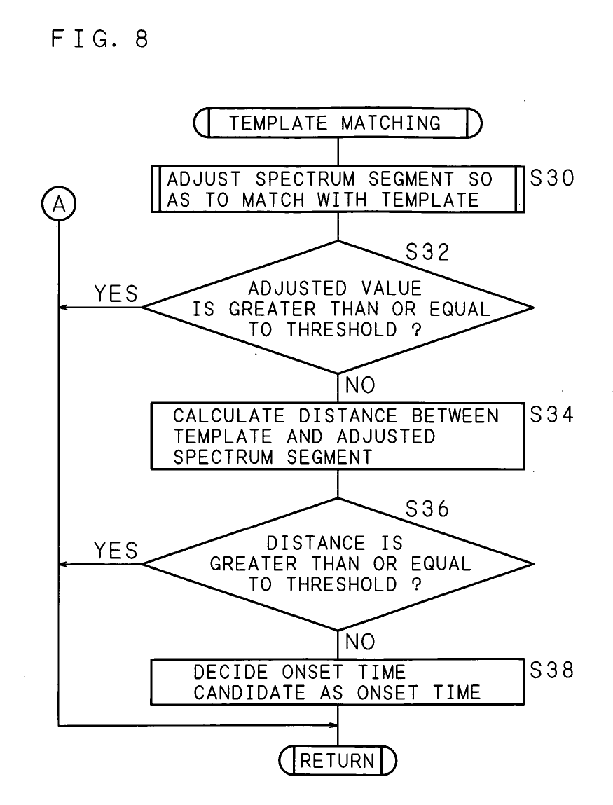

FIG. 8 is a flow chart showing, in the form of a subroutine, an exemplary detail of the procedure of template matching (S16) shown in FIG. 6. The CPU 11 first adjusts the spectrum segment Pᵢ so as to match with the template (S30). The CPU 11 then stores the adjusted spectrum segment Pᵢ′ into the HDD 13. Then, the CPU 11 calculates the amount (adjustment value Δᵢ) of change between the spectrum segments Pᵢ and Pᵢ′ before and after the power adjustment, and then stores the value into the RAM 12. The CPU 11 then compares the value with a threshold Θ stored in the HDD 13 in advance (S32). In case that the adjustment value Δᵢ is greater than or equal to the threshold Θ (S32: YES), the CPU 11 terminates the template matching process. In case that the adjustment value Δᵢ is smaller than the threshold Θ (S32: NO), the CPU 11 calculates the distance Γᵢ between the template and the adjusted spectrum segment Γᵢ′ (S34), and then stores the calculated distance Γᵢ into the HDD 13. The CPU 11 then compares the calculated distance Γᵢ with a threshold 0 stored in the HDD 13 in advance (S36). In case that the distance Γᵢ is greater than or equal to the threshold θ (S36: YES), the CPU 11 terminates the template matching process. In case that the distance Γᵢ is smaller than the threshold θ (S36: NO), the CPU 11 decides the onset time candidate oᵢ as the onset time (S38), and then stores the decided onset time into the HDD 13.

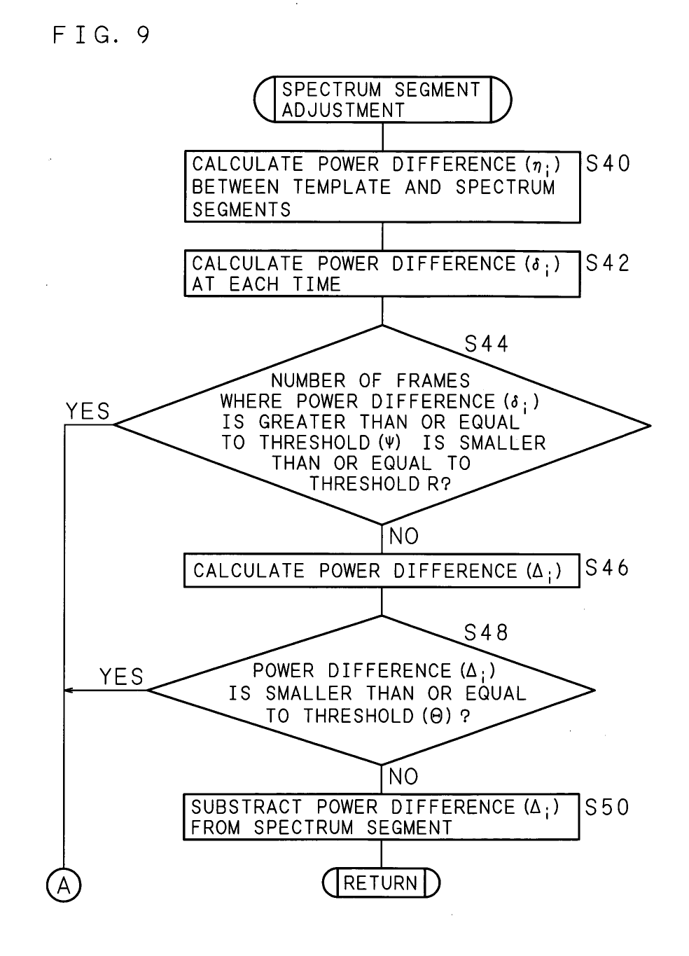

FIG. 9 is a flow chart showing, in the form of a subroutine, an exemplary detail of the procedure of spectrum segment adjustment (S30) shown in FIG. 8. The CPU 11 first calculates the power difference ηᵢ between the template TA and the spectrum segment Pᵢ at the characteristic frequency at each time (frame) (S40), and then stores the value into the RAM 12 or the HDD 13. On the basis of the calculated power difference ηᵢ at the characteristic frequency, the CPU 11 calculates the power difference δᵢ at each time (S42), and then stores the value into the RAM 12 or the HDD 13. The CPU 11 then compares the power difference δᵢ at each time with a threshold Ψ stored in the HDD 13 in advance, and thereby counts the number of frames where the power difference δᵢ is greater than or equal to the threshold Ψ. The CPU 11 stores the count into the RAM 12 or the HDD 13. The CPU 11 then compares the number of frames where the power difference δᵢ is greater than or equal to the threshold Ψ with a threshold R stored in the HDD 13 in advance (S44). In case that the number of frames where the power difference δᵢ is greater than or equal to the threshold Ψ is smaller than or equal to the threshold R (S44: YES), the CPU 11 terminates the process of adjusting the spectrum segment Pᵢ. In case that the number of frames where the power difference δᵢ is greater than or equal to the threshold Ψ is greater than the threshold R (S44: NO), the CPU 11 integrates the power difference δᵢ at each time, and thereby acquires the power difference (adjustment value Δᵢ) (S46). The CPU 11 stores the value into the HDD 13. The CPU 11 then compares the power difference Δᵢ calculated in step S46 with a threshold Γ stored in the HDD 13 in advance (S48). In case that the power difference Δᵢ is smaller than or equal to the threshold Γ (S48: YES), the CPU 11 terminates the process of adjusting the spectrum segment Pᵢ. In case that the power difference Δᵢ is greater than the threshold Θ (S48: NO), the CPU 11 subtracts the power difference Δᵢ from the spectrum segment Pᵢ (S50), and then stores the result as a spectrum segment Pᵢ′ into the HDD 13.

The above-mentioned embodiment has been described in the case that the audio signal processing apparatus according to the invention is embodied in the form of a software process using a computer. However, the invention is applicable also to various types of apparatuses for outputting an audio signal such as a recording device, an electronic musical instrument, an audio device, a portable audio device, and a portable telephone or the like.

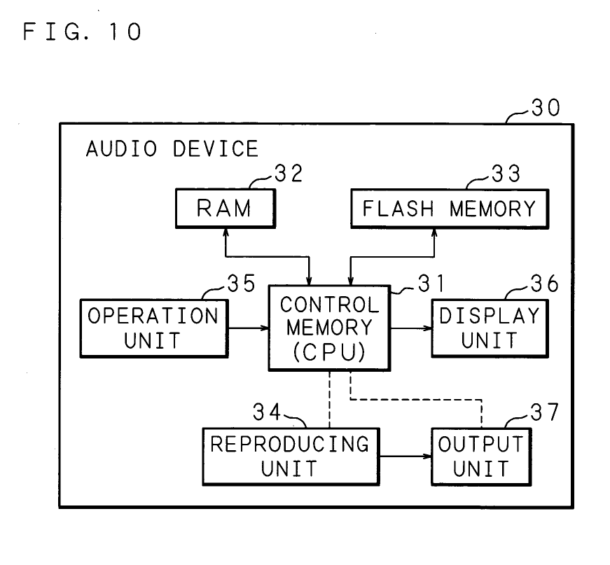

FIG. 10 is a block diagram showing an exemplary configuration of an audio signal processing apparatus according to the invention embodied as an audio device. The audio device 30 comprises: an operation unit 35 for receiving various operations such as a reproduction operation; a display unit 36 provided with a liquid crystal display panel or the like for displaying the operation status such as “in reproduction”; a reproducing unit 34 for reading data from a recording medium (not shown) such as an MD (Mini Disc), a disc of another type, and flash memory, and thereby reproducing an audio signal; an output unit 37 for outputting to a headphone or a speaker the audio signal reproduced by the reproducing unit 34; a control unit (CPU) 31 for controlling various system components such as the operation unit 35, the display unit 36, the reproducing unit 34, and the output unit 37; a RAM 32 connected to the control unit 31; and a flash memory 33 serving as a storage unit. The control unit 31 controls various system components such as the reproducing unit 34 and the output unit 37 in response to an operation received through the operation unit 35, and thereby causes an audio signal to be outputted through the output unit 37.

The control unit 31 serves as means for extracting a predetermined non-harmonic structured spectral component such as a drum sound contained in an audio signal as well as means for increasing or decreasing the extracted predetermined spectral component. The control unit 31 serves also as means for calculating the spectrum of an audio signal by frequency analysis, and thereby extracts a spectrum corresponding to the predetermined non-harmonic structured spectral component. The extraction of the predetermined non-harmonic structured spectral component is performed with reference to a spectral component of a template stored in the flash memory (storage unit) 33 in advance. The control unit 31 serves as means for adapting the spectral component of the template in such a manner that the difference between the extracted spectral component and the spectral component of the template stored in the flash memory 33 goes below or at a predetermined value. More specifically, the control unit 31 serves as in case that a plurality of spectral components have been extracted: means for calculating the difference between each extracted spectral component and the spectral component of the template; means for selecting a predetermined number of spectral components in ascending order of the calculated difference; and means for updating the spectral component of the template into the median of the predetermined number of selected spectral components. As such, the control unit 31 adapts the spectral component of the template.

The control unit 31 serves also as means for quantizing each extracted spectral component and the spectral component of the template in the initial adaptation for the spectral component of the template, and thereby calculates the difference between each extracted spectral component and the spectral component of the template that have been quantized. The operation unit 35 serves as means for receiving the amount of increase or decrease of the predetermined spectral component, so that the control unit 31 increases or decreases the extracted predetermined spectral component in response to the amount of increase or decrease received through the operation unit 35. In an example, in addition to a volume control knob for the overall power of the audio signal, the operation unit 35 comprises a volume control knob for bass drum.

Similarly to the computer shown in FIG. 1, the audio device 30 shown in FIG. 10 extracts and increases or decreases a predetermined non-harmonic structured spectral component such as a drum sound according to the invention. The control unit 31, the RAM 32, the flash memory 33, the reproducing unit 34, the operation unit 35, the display unit 36, and the output unit 37 in the audio device 30 operate respectively in a similar manner to the CPU 11, the RAM 12, the HDD 13, the external storage unit 14, the input unit 15, the display unit 16, and the sound card (not shown) in the computer 10 of FIG. 1, and thereby extract and increase or decrease a drum sound or the like.

In the configuration shown in FIG. 10, the control unit (CPU) 31 extracts and increases or decreases the drum sound or the like. However, a dedicated hardware (dedicated LSI) for extracting and increasing or decreasing the drum sound or the like may be provided so that the dedicated LSI, instead of the control unit 31, may extract and increase or decrease the predetermined non-harmonic structured spectral component such as a drum sound. Further, the audio device 30 may be provided with a communication port for performing communications with the outside. Furthermore, the reproducing unit 34 may be constructed in a manner capable of recording in addition to reproducing. As such, the invention is applicable also to arbitrary audio devices. In the case of a portable telephone, the invention may be applied in its audio signal processing unit. As such, the invention is applicable to the audio signal processing units of various devices for processing an audio signal.

The above-mentioned embodiment has been described in the case that a non-harmonic structured sound such as a drum sound is extracted and increased or decreased. However, the invention is not limited to the drum sound. A non-harmonic structured sound generated by another percussion instrument such as cymbals may be extracted and increased or decreased. Further, a non-harmonic structured sound generated by another type of sound source may be extracted and increased or decreased. Further, a bass drum sound or a snare drum sound among various types of drum sounds may be extracted and increased or decreased.

An audio signal processed according to the invention may contain a voice signal. For example, a predetermined non-harmonic structured spectral component may be extracted from an audio signal of music containing a vocal, and then the extracted spectral component may be increased or decreased. Further, a predetermined non-harmonic structured spectral component may be extracted from an audio signal containing a voice of the target of speech recognition, and then the extracted spectral component may be increased or decreased. Accordingly, in speech recognition, a predetermined non-harmonic structured spectral component contained in voice data can be extracted and decreased. Such a non-harmonic structured spectral component contained in voice data is a noise component in many cases. Thus, the noise component can be cancelled by extracting and decreasing it. This improves the accuracy in the speech recognition.

Further, the above-mentioned embodiment has been described in the case that once the onset time is decided, the power spectrum is immediately increased or decreased in the vicinity of the onset time (S16 and S18 in FIG. 6). However, the deciding of the onset time may be processed separately from the increase or decrease of the power spectrum in the vicinity of the onset time. In an example, after the onset time of a drum in an audio signal is decided, the audio signal (sound data), the onset time (onset position data), and the adapted template may be transmitted through a recording medium or a network to another computer. Then, this another computer or an audio device may increase or decrease the power spectrum in the vicinity of the onset time. More specifically, the communication unit (outputting means) 17 of the computer (first audio signal processing apparatus) shown in FIG. 1 may transmit the audio signal, the onset time, and the adapted template. Further, the external storage unit (outputting means) 14 may output such data and record it into a recording medium. Furthermore, the reproducing unit (receiving means) 34 of the audio device (second audio signal processing apparatus) shown in FIG. 10 may read the audio signal, the onset time, and the adapted template, while the control unit 31 or the like may increase or decrease the power spectrum of the audio signal corresponding to the adapted template at the onset time. Similarly, the communication unit (receiving means) 17 of the computer (second audio signal processing apparatus) shown in FIG. 1 may receive the audio signal, the onset time, and the adapted template. Further, the external storage unit (receiving means) 14 may read the audio signal, the onset time, and the adapted template, while the CPU 11 may increase or decrease the power spectrum of the audio signal corresponding to the adapted template at the onset time. Furthermore, the template adaptation may be separately performed in another audio signal processing apparatus such as a computer.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An audio signal processing method comprising steps of
extracting a predetermined non-harmonic structured spectral component contained in an audio signal; and
increasing or decreasing said extracted predetermined spectral component.

2. The audio signal processing method as set forth in claim 1, further comprising a step of calculating a spectrum of said audio signal by frequency analysis,
wherein, in said step of extracting the predetermined non-harmonic structured spectral component, a spectrum is extracted that corresponds to said predetermined non-harmonic structured spectral component.

3. The audio signal processing method as set forth in claim 2, wherein
said step of extracting the predetermined non-harmonic structured spectral component is performed with reference to a spectral component of a template stored in advance, and
said method further comprises a step of adapting said spectral component of said template in such a manner that a difference between said extracted spectral component and said spectral component of said template goes below or at a predetermined value.

4. The audio signal processing method as set forth in claim 3, wherein said adapting step further comprises steps of
calculating a difference between each extracted spectral component and said spectral component of said template in case that a plurality of spectral components have been extracted;
selecting a predetermined number of spectral components in ascending order of said calculated difference; and
updating said spectral component of said template into a median of said predetermined number of selected spectral components.

5. The audio signal processing method as set forth in claim 4, further comprising a step of quantizing said extracted spectral components and said spectral component of said template in an initial adaptation for said spectral component of said template,
wherein, in said step of calculating a difference, a difference is calculated between each extracted spectral component and said spectral component of said template which have been quantized.

6. The audio signal processing method as set forth in claim 1, further comprising a step of receiving an amount of increase or decrease for said predetermined spectral component,
wherein, in said increasing or decreasing step, said extracted predetermined spectral component is increased or decreased in response to said received amount of increase or decrease.

7. An audio signal processing method for extracting, with reference to a spectral component of a template stored in advance, a predetermined non-harmonic structured spectral component contained in an audio signal, comprising a step of adapting said spectral component of said template in such a manner that a difference between said extracted spectral component and said spectral component of said template goes below or at a predetermined value.

8. The audio signal processing method as set forth in claim 7, wherein said adapting step further comprises steps of:
calculating a difference between each extracted spectral component and said spectral component of said template in case that a plurality of spectral components have been extracted;
selecting a predetermined number of spectral components in ascending order of said calculated difference; and
updating said spectral component of said template into a median of said predetermined number of selected spectral components.

9. The audio signal processing method as set forth in claim 8, further comprising a step of quantizing said extracted spectral component and said spectral component of said template in an initial adaptation for said spectral component of said template,
wherein, in said step of calculating a difference, a difference is calculated between each extracted spectral component and said spectral component of said template which have been quantized.

10. The audio signal processing method as set forth in claim 7, further comprising a step of receiving an amount of increase or decrease for said predetermined spectral component,
wherein, in said increasing or decreasing step, said extracted predetermined spectral component is increased or decreased in response to said received amount of increase or decrease.

11. An audio signal processing method comprising steps of
extracting a predetermined non-harmonic structured spectral component contained in an audio signal;
outputting onset time information of the extraction of said predetermined non-harmonic structured spectral component from said audio signal, said predetermined spectral component, and said audio signal;
receiving said outputted onset time information, said predetermined spectral component, and said audio signal; and
increasing or decreasing said received spectral component contained in said received audio signal, on the basis of said received onset time information.

12. An audio signal processing apparatus comprising:
extracting means for extracting a predetermined non-harmonic structured spectral component contained in an audio signal; and
increasing and decreasing means for increasing or decreasing said predetermined spectral component extracted by said extracting means.

13. The audio signal processing apparatus as set forth in claim 12, further comprising calculating means for calculating a spectrum of said audio signal by frequency analysis,
wherein said extracting means extracts a spectrum corresponding to said predetermined non-harmonic structured spectral component.

14. The audio signal processing apparatus as set forth in claim 13, wherein
said extraction of a predetermined non-harmonic structured spectral component is performed with reference to a spectral component of a template stored in a storage unit in advance, and
said apparatus further comprises adapting means for adapting said spectral component of said template in such a manner that a difference between said extracted spectral component and said spectral component of said template goes below or at a predetermined value.

15. The audio signal processing apparatus as set forth in claim 14, wherein said adapting means further comprises:
subtracting means for calculating a difference between each extracted spectral component and said spectral component of said template in case that a plurality of spectral components have been extracted;
selecting means for selecting a predetermined number of spectral components in ascending order of the difference calculated by said subtracting means; and
updating means for updating said spectral component of said template into a median of said predetermined number of spectral components selected by said selecting means.

16. The audio signal processing apparatus as set forth in claim 15, further comprising quantizing means for quantizing said extracted spectral components and said spectral component of said template in an initial adaptation for said spectral component of said template,
wherein said subtracting means calculates a difference between each extracted spectral component and said spectral component of said template which have been quantized by said quantizing means.

17. The audio signal processing apparatus as set forth in claim 12, further comprising receiving means for receiving an amount of increase or decrease for said predetermined spectral component,
wherein said increasing and decreasing means increases or decreases said extracted predetermined spectral component in response to said amount of increase or decrease received by said receiving means.

18. An audio signal processing apparatus for extracting, with reference to a spectral component of a template stored in a storage unit in advance, a predetermined non-harmonic structured spectral component contained in an audio signal, comprising adapting means for adapting said spectral component of said template in such a manner that a difference between said extracted spectral component and said spectral component of said template goes below or at a predetermined value.

19. The audio signal processing apparatus as set forth in claim 18, wherein said adapting means further comprises:
subtracting means for calculating a difference between each extracted spectral component and said spectral component of said template in case that a plurality of spectral components have been extracted;
selecting means for selecting a predetermined number of spectral components in ascending order of the difference calculated by said subtracting means; and
updating means for updating said spectral component of said template into a median of said predetermined number of spectral components selected by said selecting means.

20. The audio signal processing apparatus as set forth in claim 19, further comprising quantizing means for quantizing said extracted spectral components and said spectral component of said template in an initial adaptation for said spectral component of said template,
wherein said subtracting means calculates a difference between each extracted spectral component and said spectral component of said template which have been quantized by said quantizing means.

21. The audio signal processing apparatus as set forth in claim 18, further comprising receiving means for receiving an amount of increase or decrease for said predetermined spectral component,
wherein said increasing and decreasing means increases or decreases said extracted predetermined spectral component in response to said amount of increase or decrease received by said receiving means.

22. An audio signal processing system including:
a first audio signal processing apparatus comprising: extracting means for extracting a predetermined non-harmonic structured spectral component contained in an audio signal; and outputting means for outputting onset time information of the extraction of said predetermined non-harmonic structured spectral component from said audio signal by said extracting means, said predetermined spectral component, and said audio signal; and
a second audio signal processing apparatus comprising: receiving means for receiving said onset time information, said predetermined spectral component, and said audio signal outputted from said first audio signal processing apparatus; and increasing and decreasing means for increasing or decreasing said received spectral component contained in said received audio signal, on the basis of said onset time information received by said receiving means.

23. An audio signal processing apparatus comprising:
extracting means for extracting a predetermined non-harmonic structured spectral component contained in an audio signal; and
outputting means for outputting onset time information of the extraction of said predetermined non-harmonic structured spectral component from said audio signal by said extracting means, said predetermined spectral component, and said audio signal.

24. An audio signal processing apparatus comprising:
receiving means for receiving onset time information of the extraction of a predetermined non-harmonic structured spectral component from an audio signal, said predetermined spectral component, and said audio signal; and
increasing and decreasing means for increasing or decreasing said received spectral component contained in said received audio signal, on the basis of said onset time information received by said receiving means.

25. An audio signal processing apparatus comprising a processor being capable of performing following operations of:
extracting a predetermined non-harmonic structured spectral component contained in an audio signal; and
increasing or decreasing said extracted predetermined spectral component.

26. The audio signal processing apparatus as set forth in claim 25, wherein
said processor is further capable of performing a following operation of calculating a spectrum of said audio signal by frequency analysis; and
in said operation of extracting a predetermined non-harmonic structured spectral component, a spectrum is extracted that corresponds to said predetermined non-harmonic structured spectral component.

27. The audio signal processing apparatus as set forth in claim 26, further comprising a storage unit for storing a spectral component of a template in advance, wherein
said operation of extracting a predetermined non-harmonic structured spectral component is performed with reference to a spectral component of a template stored in said storage unit in advance, and
said processor is further capable of performing a following operation of adapting said spectral component of said template in such a manner that a difference between said extracted spectral component and said spectral component of said template goes below or at a predetermined value.

28. The audio signal processing apparatus as set forth in claim 27, wherein, in said adapting operation, said processor is further capable of performing following operations of:
calculating a difference between each extracted spectral component and said spectral component of said template in case that a plurality of spectral components have been extracted;
selecting a predetermined number of spectral components in ascending order of said calculated difference; and
updating said spectral component of said template into a median of said predetermined number of selected spectral components.

29. The audio signal processing apparatus as set forth in claim 28, wherein
said processor is further capable of performing a following operation of quantizing said extracted spectral components and said spectral component of said template in an initial adaptation for said spectral component of said template, and
in said operation of calculating a difference, a difference is calculated between each extracted spectral component and said spectral component of said template which have been quantized.

30. The audio signal processing apparatus as set forth in claim 25, further comprising a receiving unit for receiving an amount of increase or decrease for said predetermined spectral component,
wherein said processor increases or decreases said extracted predetermined spectral component in response to said received amount of increase or decrease.

31. An audio signal processing apparatus comprising: a storage unit for storing a spectral component of a template in advance; and a processor for extracting, with reference to a spectral component of a template stored in said storage unit in advance, a predetermined non-harmonic structured spectral component contained in an audio signal;
wherein said processor is further capable of performing a following operation of adapting said spectral component of said template in such a manner that a difference between said extracted spectral component and said spectral component of said template goes below or at a predetermined value.

32. The audio signal processing apparatus as set forth in claim 31, wherein, in said adapting operation, said processor is further capable of performing following operations of:
calculating a difference between each extracted spectral component and said spectral component of said template in case that a plurality of spectral components have been extracted;
selecting a predetermined number of spectral components in ascending order of said calculated difference; and
updating said spectral component of said template into a median of said predetermined number of selected spectral components.

33. The audio signal processing apparatus as set forth in claim 32, wherein
said processor is further capable of performing a following operation of quantizing said extracted spectral components and said spectral component of said template in an initial adaptation for said spectral component of said template, and
in said operation of calculating a difference, a difference is calculated between each extracted spectral component and said spectral component of said template which have been quantized.

34. The audio signal processing apparatus as set forth in claim 31, further comprising a receiving unit for receiving an amount of increase or decrease for said predetermined spectral component,
wherein said processor increases or decreases said extracted predetermined spectral component in response to said received amount of increase or decrease.

35. An audio signal processing system including:
a first audio signal processing apparatus comprising a processor being capable of performing following operations of extracting a predetermined non-harmonic structured spectral component contained in an audio signal; and outputting onset time information of the extraction of said predetermined non-harmonic structured spectral component from said audio signal, said predetermined spectral component, and said audio signal; and
a second audio signal processing apparatus comprising a processor being capable of performing following operations of receiving said onset time information, said predetermined spectral component, and said audio signal outputted from said first audio signal processing apparatus; and increasing or decreasing said received spectral component contained in said received audio signal, on the basis of said received onset time information.

36. An audio signal processing apparatus comprising a processor being capable of performing following operations of:
extracting a predetermined non-harmonic structured spectral component contained in an audio signal; and
outputting onset time information of the extraction of said predetermined non-harmonic structured spectral component from said audio signal, said predetermined spectral component, and said audio signal.

37. An audio signal processing apparatus comprising a processor being capable of performing following operations of;
receiving onset time information of the extraction of a predetermined non-harmonic structured spectral component from an audio signal, said predetermined spectral component, and said audio signal; and
increasing or decreasing said received spectral component contained in said received audio signal, on the basis of said received onset time information.

38. A computer program product for causing a computer to process an audio signal, wherein said computer program product comprises:
a computer readable storage medium having computer readable program code means embodied in said medium, said computer readable program code means comprising instructions for:
extracting a predetermined non-harmonic structured spectral component contained in an audio signal; and
increasing or decreasing said extracted predetermined spectral component.

39. The computer program product as set forth in claim 38, wherein
said computer readable program code means further comprises an instruction for calculating a spectrum of said audio signal by frequency analysis, and
said extracting instruction causes said computer to extract a spectrum corresponding to said predetermined non-harmonic structured spectral component.

40. The computer program product as set forth in claim 39, wherein
said instruction for extracting a predetermined non-harmonic structured spectral component is executed with reference to a spectral component of a template stored in advance, and
said computer readable program code means further comprises an instruction for adapting said spectral component of said template in such a manner that a difference between said extracted spectral component and said spectral component of said template goes below or at a predetermined value.

41. The computer program product as set forth in claim 40, wherein, in said adapting instruction, said computer readable program code means further comprises instructions for:
calculating a difference between each extracted spectral component and said spectral component of said template in case that a plurality of spectral components have been extracted;
selecting a predetermined number of spectral components in ascending order of said calculated difference; and
updating said spectral component of said template into a median of said predetermined number of selected spectral components.

42. The computer program product as set forth in claim 41, wherein
said computer readable program code means further comprises an instruction for quantizing said extracted spectral components and said spectral component of said template in an initial adaptation for said spectral component of said template; and
said instruction for calculating a difference causes said computer to calculate a difference between each extracted spectral component and said spectral component of said template which have been quantized.

43. The computer program product as set forth in claim 38, wherein
said computer readable program code means further comprises an instruction for receiving an amount of increase or decrease for said predetermined spectral component; and
said increasing or decreasing instruction causes said computer to increase or decrease said extracted predetermined spectral component in response to said received amount of increase or decrease.

44. A computer program product for causing a computer to extract, with reference to a spectral component of a template stored in a memory in advance, a predetermined non-harmonic structured spectral component contained in an audio signal, wherein said computer program product comprises:
a computer readable storage medium having computer readable program code means embodied in said medium, said computer readable program code means comprising an instruction for adapting said spectral component of said template in such a manner that a difference between said extracted spectral component and said spectral component of said template goes below or at a predetermined value.

45. The computer program product as set forth in claim 44, wherein, in said adapting instruction, said computer readable program code means further comprises instructions for:
calculating a difference between each extracted spectral component and said spectral component of said template in case that a plurality of spectral components have been extracted;
selecting a predetermined number of spectral components in ascending order of said calculated difference; and
updating said spectral component of said template into a median of said predetermined number of selected spectral components.

46. The computer program product as set forth in claim 45, wherein
said computer readable program code means further comprises an instruction for quantizing said extracted spectral components and said spectral component of said template in an initial adaptation for said spectral component of said template; and
said instruction for calculating a difference causes said computer to calculate a difference between each extracted spectral component and said spectral component of said template which have been quantized.

47. The computer program product as set forth in claim 44, wherein
said computer readable program code means further comprises an instruction for receiving an amount of increase or decrease for said predetermined spectral component; and
said increasing or decreasing instruction causes said computer to increase or decrease said extracted predetermined spectral component in response to said received amount of increase or decrease.

48. A computer program product for causing a computer to process an audio signal, wherein said computer program product comprises:
a computer readable storage medium having computer readable program code means embodied in said medium, said computer readable program code means comprising instructions for:
extracting a predetermined non-harmonic structured spectral component contained in an audio signal; and
outputting onset time information of the extraction of said predetermined non-harmonic structured spectral component from said audio signal, said predetermined spectral component, and said audio signal.

49. A computer program product for causing a computer to process an audio signal, wherein said computer program product comprises:
a computer readable storage medium having computer readable program code means embodied in said medium, said computer readable program code means comprising instructions for:
receiving onset time information of the extraction of a predetermined non-harmonic structured spectral component from an audio signal, said predetermined spectral component, and said audio signal; and
increasing or decreasing said received spectral component contained in said received audio signal, on the basis of said received onset time information.
